(19) United States
(12) Patent Application Publication
(10) Pub. No.: US 2021/0050562 A1
(43) Pub. Date: Feb. 18, 2021

(54) BUTTON BATTERY CASE STRUCTURE, BUTTON BATTERY AND ELECTRIC DEVICE

(71) Applicant: GUANGZHOU GREAT POWER ENERGY & TECHNOLOGY CO., LTD., Guangdong (CN)

(72) Inventors: Jianjun XUE, Guangdong (CN); Biao GUO, Guangdong (CN); Xinde XIA, Guangdong (CN); Yan DING, Guangdong (CN); Bin ZHOU, Guangdong (CN); Aizhong YIN, Guangdong (CN); Jiahui CHEN, Guangdong (CN)

(73) Assignee: GUANGZHOU GREAT POWER ENERGY & TECHNOLOGY CO., LTD., Guangdong (CN)

(21) Appl. No.: 16/976,306

(22) PCT Filed: Nov. 23, 2018
(86) PCT No.: PCT/CN2018/117100

§ 371 Date: Aug. 27, 2020

(30) Foreign Application Priority Data
Nov. 6, 2018 (CN) 201811314209.X

(51) Int. Cl. H01M 2/02; H01M 2/04; H01M 2/08

(52) U.S. Cl. CPC H01M 2/0222; H01M 2220/30; H01M 2/08; H01M 2/0404

(57) ABSTRACT

A case structure for button battery, a button battery and an electric device are provided. A lower cover of the case structure includes an upper segment of second sidewall and a lower segment of second sidewall; the upper segment of second sidewall has a diameter greater than that of the lower segment of second sidewall; a sealing ring is installed between an upper cover and the lower cover; the sealing ring has a height adapted to that of the upper segment of second sidewall, and the sealing ring is installed in an inner cavity of the upper segment of second sidewall; the upper cover is installed in the inner cavity of the upper segment of second sidewall, and a battery core is installed in an inner cavity of the lower segment of second sidewall.

### CROSS-REFERENCE TO RELATED APPLICATION

The present disclosure claims priority of Chinese Patent Application with the filing number 201811314209X filed on Nov. 6, 2018 with the Chinese Patent Office and entitled “Case Structure for Button Battery, Button Battery and Electric Device”, the contents of which are incorporated herein by reference in their entirety.

### TECHNICAL FIELD

The present disclosure relates to the technical field of batteries, in particular to a case structure for button battery, a button battery and an electric device.

### BACKGROUND ART

Button battery, also called as button cell, refers to a battery that is shaped and sized like a small button, generally speaking, it has a larger diameter, and a smaller thickness. The button battery is widely applied to various microelectronic products due to its relatively small size, and has a diameter of 4.8 mm to 30 mm and a thickness of 1.0 mm to 7.7 mm etc.; the button battery is usually used as a backup power supply for various types of electronic products, for example, computer mainboard, electronic watch, electronic dictionary, electronic scale, remote control, electronic toy, cardiac pacemaker, electronic hearing aid, a counter and camera.

Button batteries are also classified into two major types, chemical button batteries and physical button batteries, among which the chemical button batteries are most commonly used. They consist of an anode (positive electrode), a cathode (negative electrode), an electrolyte and so on. The surface of the battery is made of a stainless steel material and is used as a positive electrode, the negative electrode of the battery is a stainless steel circular cover, there is an insulation sealing ring made of nylon between the positive electrode and the negative electrode, and apart from the insulation function, the sealing ring further can prevent electrolyte leakage. Button batteries are of various types, and most of them are named by materials used, for example, silver oxide batteries, lithium batteries, alkaline manganese batteries and so on.

However, problems of deformation and leakage easily occur during use of the button batteries in the prior art.

### SUMMARY

Objects of the present disclosure include, for example, providing a case structure for button battery, a button battery and an electric device, so as to solve the technical problems that deformation and leakage easily occur to the button batteries in the prior art during use.

An embodiment of the present disclosure can be realized as follows:

An embodiment of the present disclosure provides a case structure for button battery, including:

an upper cover;

a lower cover, wherein the upper cover and the lower cover are installed with each other in a snap-fit manner;

the lower cover includes an upper segment of second sidewall and a lower segment of second sidewall, wherein the upper segment of second sidewall has a diameter greater than that of the lower segment of second sidewall; and

a sealing ring, wherein the sealing ring is installed between the upper cover and the lower cover, and configured to seal the upper cover and the lower cover;

wherein the sealing ring has a height adapted to that of the upper segment of second sidewall, and the sealing ring is installed in an inner cavity formed by the upper segment of second sidewall, and is tightly attached to an inner wall formed by the upper segment of second sidewall; and

the upper cover is installed in the inner cavity formed by the upper segment of second sidewall, and a battery core is installed in an inner cavity of the lower segment of second sidewall.

Optionally, in an embodiment of the present disclosure, a platform structure is provided between the upper segment of second sidewall and the lower segment of second sidewall, wherein the platform structure is configured to restrain axial movement of the sealing ring along the lower cover.

Optionally, in an embodiment of the present disclosure, a distance between the platform structure and the bottom portion of the lower cover is 2-6 mm.

Optionally, in an embodiment of the present disclosure, the inner wall of the upper segment of second sidewall is perpendicular to the inner wall of the platform structure, and the inner wall of the platform structure is perpendicular to the inner wall of the lower segment of second sidewall.

Optionally, in an embodiment of the present disclosure, a distance between the inner wall of the platform structure and the bottom portion of the lower cover is equal to a distance between the inner wall of the platform structure and the top portion of the lower cover; or the inner wall of the platform structure is closer to the top portion of the lower cover relative to the bottom portion of the lower cover.

Optionally, in an embodiment of the present disclosure, the diameter of the upper segment of second sidewall is less than 20 mm.

Optionally, in an embodiment of the present disclosure, a diameter ratio of the upper segment of second sidewall to the lower segment of second sidewall is 1:0.8-0.98.

Optionally, in an embodiment of the present disclosure, the upper cover includes an upper segment of first sidewall and a lower segment of first sidewall;

wherein the upper segment of first sidewall has a smaller diameter than that of the lower segment of first sidewall; and

a transitional inclined side wall is provided between the upper segment of first sidewall and the lower segment of first sidewall.

Optionally, in an embodiment of the present disclosure, the battery core includes a positive electrode plate, a negative electrode plate and a separator film;

wherein the positive electrode plate, the negative electrode plate and the separator film are combined into the battery core by winding or lamination.

Optionally, in an embodiment of the present disclosure, a main material of the positive electrode plate includes any one or a combination of lithium cobaltate, lithium manganate, lithium cobalt nickel manganate, lithium cobalt nickel aluminate, and lithium iron ferrous phosphate;

and/or, a main material of the negative electrode plate includes any one or a combination of lithium titanate, silicon carbon, artificial graphite, and natural graphite;

and/or, a material of the separator film includes any one of polyethylene, polypropylene, polyethylene terephthalate and polyimide.

Optionally, in an embodiment of the present disclosure, a material of the sealing ring includes either or a combination of polyethylene and polypropylene.

Optionally, in an embodiment of the present disclosure, an annular insertion sealing groove is provided in a top wall of the sealing ring along a circumferential direction of the sealing ring, wherein the insertion sealing groove is configured to be in connected with the lower segment of first sidewall of the upper cover by insertion; and

the lower segment of first sidewall of the upper cover is inserted into the insertion sealing groove of the sealing ring for sealing fit.

Optionally, in an embodiment of the present disclosure, a diameter of the inner wall of the upper segment of first sidewall is equal to that of the lower segment of second sidewall.

Optionally, in an embodiment of the present disclosure, the upper cover includes the upper segment of first sidewall and the lower segment of first sidewall arranged in sequence, wherein the lower segment of first sidewall is bent in a direction away from the inside of the upper cover;

an annular insertion sealing groove is formed in the inner wall of the sealing ring along the circumferential direction of the sealing ring, and the insertion sealing groove is configured to be connected with the lower segment of first sidewall of the upper cover by insertion; and

the lower segment of first sidewall of the upper cover is inserted into the insertion sealing groove of the sealing ring for sealing fit.

Optionally, in an embodiment of the present disclosure, the diameter of the inner wall of the upper segment of first sidewall is smaller than that of the lower segment of second sidewall.

Optionally, in an embodiment of the present disclosure, the top portion of the lower cover is provided with a bent portion circumferentially extending along the top portion of the lower cover, wherein the bent portion is configured to be snap-fitted with the sealing ring.

An embodiment of the present disclosure further provides a button battery, including the case structure for button battery.

An embodiment of the present disclosure further provides an electric device, including the button battery.

Compared with the prior art, beneficial effects of the embodiments of the present disclosure include, for example:

In the above technical solutions, in order to ensure the capability of pressure resistance of the case structure for button battery, the lower cover is divided into the upper segment of second sidewall and the lower segment of second sidewall, and then the upper cover and the sealing ring are installed according to the separation of the lower cover by the upper segment of second sidewall and the lower segment of second sidewall.

Meanwhile, heights of the upper cover and the sealing ring are reduced compared with those in the structure of the button battery in the prior art, and the upper cover and the sealing ring can be only installed in the inner cavity formed by the upper segment of second sidewall of the lower cover, but cannot extend or be installed to the bottom portion of the lower cover. Reducing the heights of the upper cover and the sealing ring can reduce the force-bearing height of the side wall, thereby obtaining higher pressure resistance.

In addition, the diameter of the upper segment of second sidewall of the lower cover is greater than that of the lower segment of second sidewall, the battery core of the battery is installed in the inner cavity formed by the lower segment of second sidewall, and the smaller diameter of the lower segment of second sidewall compared with the upper segment of second sidewall can directly exert an inward pressure for fixation, so that it is ensured that most of the swelling pressure of the battery core is applied to the lower segment of second sidewall.

To sum up, such improved structure greatly improves the sealing strength of the battery, so as to ensure the tightness of the battery at the seal when the internal pressure is increased, avoid leakage and deformation, and effectively improve the cycling life and safety performance of the battery. Meanwhile, the reduction of sizes of the upper cover and the sealing ring provides a larger effective space, and significantly improves the battery capacity.

In addition, as the upper cover and the sealing ring both are shortened, there is a larger effective space in the bottom portion, and the battery's capacity will be effectively increased. Meanwhile, with the same diameter of the bottom portion, an effective inner diameter is larger after combination, so that the battery core's size will relatively get larger, and the capacity of the battery also will be effectively improved.

### BRIEF DESCRIPTION OF DRAWINGS

In order to more clearly illustrate technical solutions of embodiments of the present disclosure, accompanying drawings which need to be used in the embodiments will be introduced below briefly, and it should be understood that the accompanying drawings below merely show some embodiments of the present disclosure, and therefore should not be considered as limitation to the scope, and a person ordinarily skilled in the art still could obtain other relevant accompanying drawings according to these accompanying drawings, without creative efforts.

FIG. 1 is a sectional view of a first case structure for button battery provided in an embodiment of the present disclosure;

FIG. 2 is a sectional view of a second case structure for button battery provided in an embodiment of the present disclosure;

FIG. 3 is a structural schematic view of an upper cover in FIG. 2;

FIG. 4 is a structural schematic view of a lower cover in FIG. 2;

FIG. 5 is a sectional view of a third type of case structure for button battery provided in an embodiment of the present disclosure;

FIG. 6 is a structural schematic view of the upper cover in FIG. 5; and

FIG. 7 is a structural schematic view of the lower cover in FIG. 5.

Reference signs: 1-upper cover; 11-upper segment of first sidewall; 12-lower segment of first sidewall; 13-inclined side wall; 2-lower cover; 21-upper segment of second sidewall; 22-lower segment of second sidewall; 23-platform structure; 24-bent portion; 3-sealing ring; 31-insertion sealing groove; 4-battery core; 41-positive electrode plate; 42-negative electrode plate; 43-separator film.

### DETAILED DESCRIPTION OF EMBODIMENTS

In order to make objects, technical solutions and advantages of the embodiments of the present disclosure clearer, the technical solutions in the embodiments of the present disclosure will be described below clearly and completely in conjunction with the accompanying drawings in the embodiments of the present disclosure, and apparently, some but not all embodiments of the present disclosure are described. Generally, components in the embodiments of the present disclosure described and shown in the accompanying drawings herein can be arranged and designed in different configurations.

Therefore, the detailed description below of the embodiments of the present disclosure provided in the accompanying drawings is not intended to limit the scope of protection of the present disclosure, but merely represents selected embodiments of the present disclosure. Based on the embodiments of the present disclosure, all other embodiments obtained by those ordinarily skilled in the art without using creative efforts shall fall within the scope of protection of the present disclosure.

It should be noted that similar reference signs and letters represent similar items in the following accompanying drawings, therefore, once a certain item is defined in one accompanying drawing, it is not needed to be further defined or explained in subsequent accompanying drawings.

In the description of the present disclosure, it should be noted that orientational or positional relations indicated by terms such as “center”, “upper”, “lower”, “left”, “right”, “vertical”, “horizontal”, “inner”, and “outer” are based on orientational or positional relations as shown in the accompanying drawings, or orientational or positional relations of a product of the present disclosure when being conventionally placed in use, merely for facilitating describing the present disclosure and simplifying the description, rather than indicating or implying that related devices or elements have to be in the specific orientation or configured and operated in a specific orientation, therefore, they should not be construed as limitations on the present disclosure.

Besides, terms such as “first”, “second”, and “third” are merely for distinctive description, but should not be construed as indicating or implying importance in the relativity.

Moreover, terms such as “horizontal”, “vertical”, and “pendulous”, if appear, do not mean that a component is required to be absolutely horizontal or pendulous, but mean that the component can be slightly inclined. For example, by “horizontal” it merely means that a structure is more horizontal in comparison with “vertical”, rather than being completely horizontal, while the structure can be slightly inclined.

In the description of the present disclosure, it also should be noted that unless otherwise specified and defined clearly, terms “provide”, “mount”, “join”, and “connect”, if appear, should be understood in a broad sense, for example, a connection can be a fixed connection, a detachable connection, or an integrated connection; it can be a mechanical connection or an electrical connection; it can be a direct connection or an indirect connection through an intermediate medium, and it also can be an inner communication between two elements. For a person ordinarily skilled in the art, specific meanings of the above-mentioned terms in the present disclosure can be understood according to specific circumstances.

It should be noted that the features of the embodiments in the present disclosure may be combined with each other if there is no conflict.

It is found by research on the structure of the button battery in the prior art found that the cause of easy occurrence of deformation and leakage to the button battery is defects in the structural design thereof.

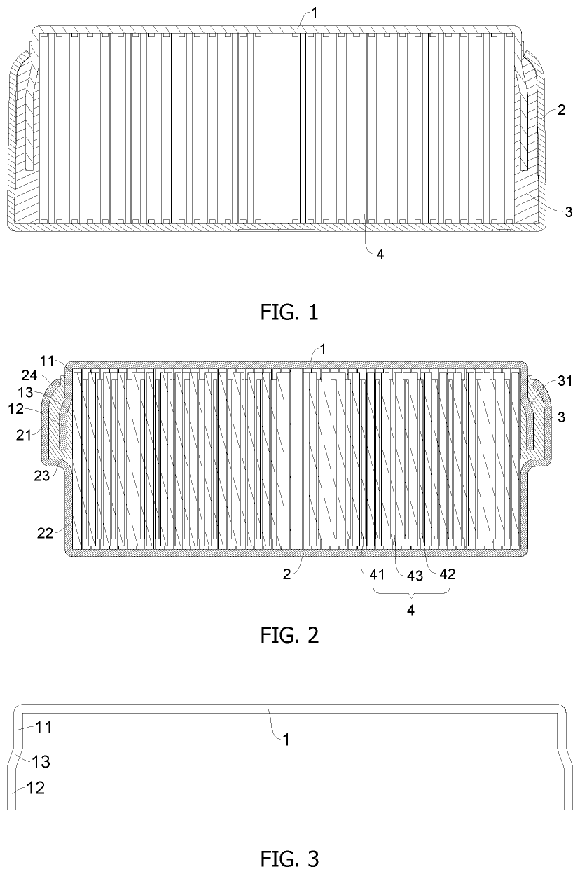

As shown in FIG. 1, in a first case (or housing, shell) structure for button battery provided in the present embodiment, at a seal of a button battery, an upper end of a lower cover 2 is bent so as to be snap-fitted with a sealing ring 3 for sealing, wherein an upper end of an upper cover 1 cooperates with the upper end of the lower cover 2 to provide a pressure of tightening from sides towards a center of the battery.

In this way, as an internal pressure of the battery will be increased due to a plurality of reasons during the manufacturing, storage and use of the button battery, for example:

1. a gas will be generated in the process of battery formation, so that the internal pressure of the battery is increased;

2. high-temperature storage of the battery accelerates a process of aging, and a battery core 4 will slightly swell, and also will generate a gas, so that the internal pressure of the battery is increased; and

3. the battery core 4 also swells during use of the battery, and will generate an outward pressure to a side wall of the battery,

therefore as the internal pressure of the button battery increases, an outward pressure will be generated, and when the upper cover 1 and the lower cover 2 are snap-fitted with each other, the upper cover 1 extends from a top portion of the lower cover to a bottom portion of the lower cover 2, then the whole height thereof is the height of a side wall of the button battery, and a force-bearing height is relatively long, thus the internal pressure that can be withstood is limited, and the battery will usually swell and deform from the side wall, and crack and leak from the top portion of the lower cover 2.

In order to solve the problems of deformation and leakage of the button battery in the prior art or improve the technical solution of the first case structure for button battery above, the present embodiment further provides a following technical solution, in which cooperation structures among the upper cover 1, the lower cover 2 and the sealing ring 3 of the button battery are all further improved, specifically as follows.

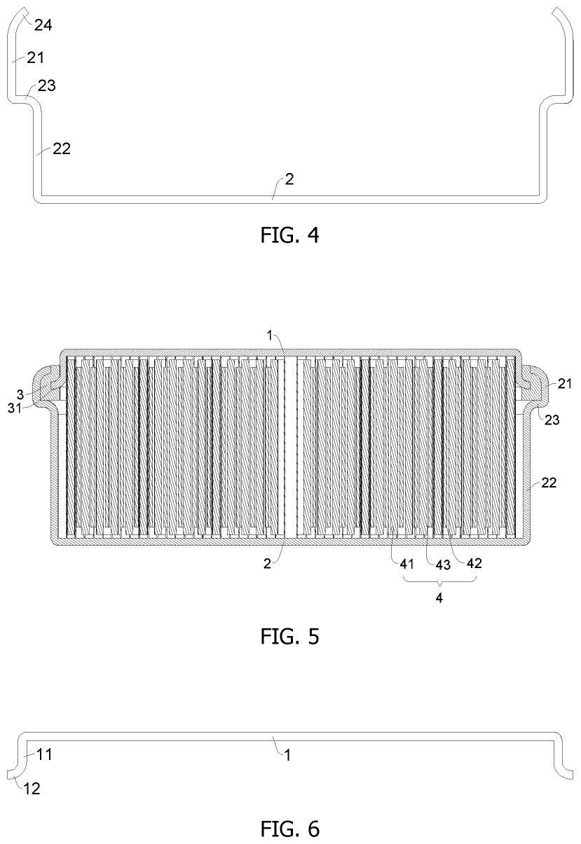

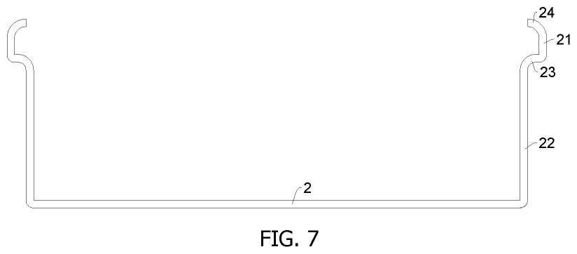

FIG. 2 is a sectional view of a second case structure for button battery provided in an embodiment of the present embodiment; FIG. 3 is a structural schematic view of the upper cover in FIG. 2; FIG. 4 is a structural schematic view of the lower cover in FIG. 2; FIG. 5 is a sectional view of a third case structure for button battery provided in the present embodiment; FIG. 6 is a structural schematic view of the upper cover in FIG. 5; and FIG. 7 is a structural schematic view of the lower cover in FIG. 5.

As shown in FIG. 2 or FIG. 5, the present embodiment provides a case structure for button battery, including:

an upper cover 1;

a lower cover 2, wherein the upper cover 1 and the lower cover 2 are installed with each other in a snap-fit manner;

the lower cover 2 includes an upper segment of second sidewall 21 and a lower segment of second sidewall 22; and the upper segment of second sidewall 21 has a diameter greater than that of the lower segment of second sidewall 22; and

a sealing ring 3, wherein the sealing ring 3 is installed between the upper cover 1 and the lower cover 2, and configured to seal the upper cover 1 and the lower cover 2;

wherein the sealing ring 3 has a height adapted to that of the upper segment of second sidewall 21, and the sealing ring 3 is installed in an inner cavity formed by the upper segment of second sidewall 21, and is tightly attached to an inner wall of the upper segment of second sidewall 21;

the upper cover 1 is installed in the inner cavity formed by the upper segment of second sidewall 21, and a battery core 4 is installed in an inner cavity formed by the lower segment of second sidewall 22.

In the case structure for button battery provided in the present embodiment, in order to ensure a capability of the pressure resistance of the case structure for button battery, the lower cover 2 is divided into the upper segment of second sidewall 21 and the lower segment of second sidewall 22, and then the upper cover 1 and the sealing ring 3 are installed according to the separation of the lower cover 2 by the upper segment of second sidewall 21 and the lower segment of second sidewall 22.

Meanwhile, heights of the upper cover 1 and the sealing ring 3 are relatively reduced, and in comparison between FIG. 1 and FIG. 2, the upper cover 1 and the sealing ring 3 shown in FIG. 2 can be only installed in the inner cavity formed by the upper segment of second sidewall 21 of the lower cover 2, but cannot extend to or be installed into the bottom portion of the lower cover 2.

It should be noted that, taking the relative position shown in FIG. 2 for introduction, the bottom portion of the lower cover 2 is a portion of the lower cover 2 away from the upper cover 1.

The material of the sealing ring 3 includes polyethylene, polypropylene or a mixture thereof.

Reducing the heights of the upper cover 1 and the sealing ring 3 can reduce the height-bearing height of the side wall, thereby obtaining higher pressure resistance.

In addition, the diameter of the upper segment of second sidewall 21 of the lower cover 2 is greater than that of the lower segment of second sidewall 22, the battery core 4 of the battery is installed in the inner cavity formed by the lower segment of second sidewall 22, and the smaller diameter of the lower segment of second sidewall 22 compared with the upper segment of second sidewall 21 can directly exert a inward pressure for fixation, so that it is ensured that most of the swelling pressure of the battery core 4 is applied to the lower segment of second sidewall 22.

In summary, the lower segment of second sidewall 22 bears a swelling pressure from the battery core 4 and does not deform, the moment of the upper segment of second sidewall 21 becomes smaller to provide an increased pressure, then combining the two aspects, the battery still does not deform or leak when the battery core 4 swells and the internal pressure is increased. Thus the above technical problems are solved.

In addition, as the upper cover 1 and the sealing ring 3 both are shortened, an effective space in the bottom portion of the lower cover 2 becomes larger, and the battery's capacity will be effectively increased. Meanwhile, with the same diameter of the bottom portion of the lower cover 2, an effective inner diameter is larger after the upper cover 1, the lower cover 2 and the sealing ring 3 are combined, so that the battery's size will relatively become larger, and the capacity of the battery also will be effectively improved.

Optionally, a platform structure 23 is provided between the upper segment of second sidewall 21 and the lower segment of second sidewall 22, and the platform structure 23 is configured to restrain axial movement of the sealing ring 3 along the lower cover 2.

In combination with FIG. 2 and FIG. 4, a distance between the platform structure 23 and the bottom portion of the lower cover 2 is 2-6 mm, and it can be understood that the platform structure 23 is located at a height of 2-6 mm of the lower cover 2, for example, 2 mm, 3 mm, 4 mm, 5 mm, and 6 mm.

Therefore, after the platform structure 23 is provided between the upper segment of second sidewall 21 and the lower segment of second sidewall 22, the sealing ring 3 installed in the inner cavity formed by the upper segment of second sidewall 21 can be restrained on the platform structure 23.

Restrained by the platform structure 23, the sealing ring 3 can be firmly installed in the inner cavity formed by the upper segment of second sidewall 21 and will not slide down into the inner cavity formed by the lower segment of second sidewall 22, and meanwhile, the upper cover 1 can also be stably installed in the inner cavity formed by the upper segment of second sidewall 21.

In this way, not only the installation stability of the upper cover 1 and the sealing ring 3 on the lower cover 2 can be ensured, but also stable installation of the upper cover 1 and the sealing ring 3 in the inner cavity formed by the upper segment of second sidewall 21 can be ensured, thus maintaining the above structure, ensuring a relatively short conduction distance of the upper segment of second sidewall 21 and ensuring that most of the swelling pressure from the battery core 4 be applied on the lower segment of second sidewall 22, so that no deformation and no leakage of the button battery are ensured.

Such improved “T”-shaped structure (i.e., the platform structure 23) enables a reduced side wall distance of the lower cover 2 compared with the corresponding distance in a battery having a conventional snap-fit structure, and the conduction distance is reduced, therefore, the pressure that can be provided is increased, and the battery is not prone to deform. Meanwhile, the moment of a side wall at the position of the “T” platform is reduced, and the pressure provided is increased, which can prevent deformation and leakage of the button battery. As the sealing ring 3 and the side wall of the upper cover 1 are shortened, the effective space inside the battery is increased, and the battery capacity is effectively improved.

It should be noted that, in FIG. 2, the inner wall of the upper segment of second sidewall 21 is perpendicular or substantially perpendicular to the inner wall of the platform structure 23, and the inner wall of the platform structure 23 is perpendicular or substantially perpendicular to the inner wall of the lower segment of second sidewall 22. Meanwhile, arc transition surfaces are formed at joints between the platform structure 23 and the inner wall of the upper segment of second sidewall 21, and between the platform structure and the inner wall of the lower segment of second sidewall 22. In other embodiments, an inclined side wall also can be provided between the upper segment of second sidewall 21 and the lower segment of second sidewall 22 so as to achieve a smooth transition.

Optionally, in combination with FIG. 2 and FIG. 4, a distance between the inner wall of the platform structure 23 and the bottom portion of the lower cover 2 is equal to a distance between the inner wall of the platform structure 23 and the top portion of the lower cover 2.

Optionally, in combination with FIG. 5, the inner wall of the platform structure 23 is closer to the top portion of the lower cover 2 relative to the bottom portion of the lower cover 2.

It should be noted that in FIG. 2, the top portion of the lower cover 2 refers to an end portion of the lower cover 2 close to the upper cover 1.

Optionally, the diameter of the upper segment of second sidewall 21 is less than 20 mm, for example, 19 mm, 17 mm, and 16 mm.

A diameter ratio of the upper segment of second sidewall 21 to the lower segment of second sidewall 22 is 1:0.8-0.98, for example, 1:0.8, 1:0.9, 1:0.95, and 1:0.98.

Optionally, the upper cover 1 includes an upper segment of first sidewall 11 and a lower segment of first sidewall 12;

the upper segment of first sidewall 11 has a smaller diameter than that of the lower segment of first sidewall 12; and

a transitional inclined side wall 13 is provided between the upper segment of first sidewall 11 and the lower segment of first sidewall 12.

Therefore, structures of the upper segment of first sidewall 11 and the lower segment of first sidewall 12 of the upper cover 1 can be cooperatively installed with the upper segment of second sidewall 21 and the lower segment of second sidewall 22 of the lower cover 2, ensuring installation stability of the upper cover 1 and the lower cover 2. The transitional inclined side wall 13 can be adapted to the structure of the lower cover 2, and tightness of installation between the lower cover and the sealing ring 3 can be increased.

Optionally, the battery core 4 includes a positive electrode plate 41, a negative electrode plate 42 and a separator film 43;

wherein the positive electrode plate 41, the negative electrode plate 42 and the separator film 43 are combined into the battery core 4 by means of winding or lamination.

Optionally, the main material of the positive electrode plate 41 includes any one or a combination of lithium cobaltate, lithium manganate, lithium cobalt nickel manganate, lithium cobalt nickel aluminate, and lithium iron ferrous phosphate;

and/or, the main material of the negative electrode plate 42 includes any one or a combination of lithium titanate, silicon carbon, artificial graphite, and natural graphite;

and/or, the material of the separator film 43 includes any one of polyethylene, polypropylene, polyethylene terephthalate and polyimide.

That is to say, the main material of the positive electrode plate 41 may be lithium cobaltate, lithium manganate, lithium cobalt nickel manganate, lithium cobalt nickel aluminate, and lithium iron ferrous phosphate or a mixture thereof.

The main material of the negative electrode plate 42 may be lithium titanate, silicon carbon, artificial graphite, and natural graphite or a mixture thereof.

The separator film 43 is a high molecular polymer film made of at least one material selected from the group consisting of polyethylene, polypropylene, polyethylene terephthalate and polyimide.

In manufacturing, the positive electrode plate 41, the negative electrode plate 42, and the separator film 43 form one battery core 4 by winding, and the separator film 43 is disposed between the positive electrode and the negative electrode during the winding. In practical production, assembling of the battery needs to be realized further through drying, liquid injection, cover closing, and sealing. According to the conventional process, the manufacturing of the battery is completed through formation, capacity grading, and detection of the battery's capacity and other electrical properties.

Lithium ion batteries with models such as 1254 and 1454 are manufactured according to the same design process in the above, a design voltage thereof is 4.2 V, and the battery performance parameters are as shown in the following table.

| | | | | | | | High- | Low- |
|---|---|---|---|---|---|---|---|---|
| | | | | Discharging | Internal | | temperature | temperature |
| | Diameter | Height | Voltage | Capacity | Resistance | Cycling | Discharging | Discharging |
| Model | (mm) | (mm) | (V) | (mAh) | (mΩ) | Life | (%) | (%) |
| 1254 | 12.1 | 5.4 | 4.2 | 65 | 350 | 600 | 105 | 75 |
| 1454 | 14.1 | 5.4 | 4.2 | 88 | 350 | 600 | 110 | 75 |

In combination with FIG. 2, optionally, an annular insertion sealing groove 31 is provided in a top wall of the sealing ring 3 along a circumferential direction of the sealing ring 3, and the insertion sealing groove 31 is configured to be connected with the lower segment of first sidewall 12 of the upper cover 1 by insertion;

the lower segment of first sidewall 12 of the upper cover 1 is inserted into the insertion sealing groove 31 of the sealing ring 3 to achieve a seal fit.

It should be noted that as shown in FIG. 2, the top wall of the sealing ring 3 is located in an upper portion of the sealing ring 3.

Therefore, by the seal fit provided by the insertion of the lower segment of first sidewall 12 of the upper cover 1 into the insertion sealing groove 31 of the sealing ring 3, firmness of installation of the sealing ring 3 between the upper cover 1 and the lower cover 2 can be improved, and meanwhile the sealing effect also can be increased.

In combination with FIG. 5, optionally, the upper cover 1 includes the upper segment of first sidewall 11 and the lower segment of first sidewall 12 arranged in sequence, wherein the lower segment of first sidewall 12 is bent in a direction away from the inside of the upper cover 1; the annular insertion sealing groove 31 is formed in the inner wall of the sealing ring 3 along the circumferential direction of the sealing ring 3, and the insertion sealing groove 31 is configured to be connected with the lower segment of first sidewall 12 of the upper cover 1 by insertion; and the lower segment of first sidewall 12 of the upper cover 1 is inserted into the insertion sealing groove 31 of the sealing ring 3 to achieve a seal fit.

In combination with FIG. 5, optionally, the upper segment of first sidewall 11 has an inner wall diameter smaller than that of the lower segment of second sidewall 22.

In combination with FIG. 2 and FIG. 5, optionally, the top portion of the lower cover 2 is provided with a bent portion 24 circumferentially extending along the top portion of the lower cover 2, wherein the bent portion 24 is configured to be snap-fitted with the sealing ring 3, and it can also be construed as that the periphery of the top portion of the lower cover 2 is bent inwards to realize snap-fit with the sealing ring 3, so as to snap-fit the upper cover 1.

Therefore, by the inwardly bent structure on the lower cover 2, the upper cover 1 can fixed in a snap-fit manner, which increases the installation firmness between the upper cover 1 and the lower cover 2, and meanwhile more tight cooperation and installation with the sealing ring 3 also can be realized.

Optionally, in combination with FIG. 2, the upper segment of first sidewall 11 has an inner wall diameter equal to that of the lower segment of second sidewall 22.

The present embodiment further provides a button battery, including the above case structure for button battery.

This button battery further includes electrolyte between the upper cover 1 and the lower cover 2.

As the specific structure, functional principle and technical effects of the case structure for button battery are described in detail in the preceding, they are not to be repeated redundantly herein.

Therefore, for any technical contents concerning the case structure for button battery, reference can be made to the disclosure about the case structure for button battery in the preceding.

The present embodiment further provides an electric device, including the above button battery.

This electric device may be a computer mainboard, an electronic watch, an electronic dictionary, an electronic scale, a remote control, an electric toy, a cardiac pacemaker, an electronic hearing aid, a counter, a camera and so on where a button battery is suitable to be installed.

As the specific structure, functional principle and technical effects of the button battery and the case structure for button battery are described in detail in the preceding, they are not repeated redundantly herein.

Therefore, for any technical contents concerning the button battery and the case structure for button battery, reference can be made to the preceding disclosure.

In Some Embodiments:

Referring to FIG. 1: the case structure for button battery shown in FIG. 1 includes the upper cover 1, the lower cover 2 and the sealing ring 3, wherein the upper cover 1 and the lower cover 2 are installed with each other in a snap-fit manner, and a relatively sealed space is formed between the upper cover 1 and the lower cover 2, wherein the sealing ring 3 is accommodated inside the lower cover 2 and closely attached to the inner wall of the lower cover 2, and extends to the bottom portion of the lower cover 2 along the top portion of the lower cover 2, a lower end of the upper cover 1 is inserted into the sealing ring 3 to realize a sealing therebetween, the upper cover 1 extends from the top portion of the lower cover 2 to the bottom portion of the lower cover 2, and the upper end of the lower cover 2 is bent so as to be snap-fitted with the sealing ring 3 and apply a pressure to the upper cover 1, thereby realizing sealing. The battery core 4 is installed in the inner cavity of the lower cover 2.

Referring to FIG. 2-FIG. 4, the case structure for button battery shown in FIG. 2 includes the upper cover 1, the lower cover 2 and the sealing ring 3, wherein the upper cover 1 and the lower cover 2 are installed with each other in a snap-fit manner, and the relatively sealed space is formed between the upper cover 1 and the lower cover 2; FIG. 3 shows the upper cover 1 in FIG. 2, wherein the upper cover 1 includes the upper segment of first sidewall 11, the inclined side wall 13, and the lower segment of first sidewall 12 that are arranged in sequence, wherein the upper segment of first sidewall 11 has a smaller diameter than that of the lower segment of first sidewall 12; FIG. 4 shows the lower cover 2 in FIG. 2, wherein the lower cover 2 includes the bent portion 24, the upper segment of second sidewall 21, the platform structure 23, and the lower segment of second sidewall 22 arranged in sequence; the bent portion 24 is located at the top portion of the lower cover 2, the bent portion 24 is bent in a direction towards the inside of the lower cover 2, the upper segment of second sidewall 21 has a diameter greater than that of the lower segment of second sidewall 22, the inner wall of the upper segment of second sidewall 21 is perpendicular to the inner wall of the platform structure 23, the inner wall of the platform structure 23 is perpendicular to the inner wall of the lower segment of second sidewall 22, and the distance between the inner wall of the platform structure 23 and the bottom portion of the lower cover 2 is equal to the distance between the inner wall of the platform structure 23 and the top portion of the lower cover 2; the sealing ring 3 is installed between the upper cover 1 and the lower cover 2 and configured to seal the space between the upper cover and the lower cover, the sealing ring 3 is installed in the inner cavity formed by the upper segment of second sidewall 21 and closely attached to the inner wall of the upper segment of second sidewall 21, the bottom portion of the sealing ring 3 abuts against the platform structure 23, and the platform structure 23 is configured to restrain the axial movement of the sealing ring 3 along the lower cover 2; the annular insertion sealing groove 31 is provided in the top wall of the sealing ring 3 along the circumferential direction of the sealing ring 3, the lower segment of first sidewall 12 of the upper cover 1 is inserted into the insertion sealing groove 31 to realize sealing fit, and the bent portion 24 is snap-fitted with the top wall of the sealing ring 3 so as to close the seal; the upper segment of first sidewall 11, the lower segment of first sidewall 12 and the inclined side wall 13 are all located in the inner cavity formed by the upper segment of second sidewall 21; the upper segment of first sidewall 11 has the inner wall diameter equal to that of the lower segment of second sidewall 22; the battery core 4 is installed in the inner cavity formed by the lower segment of second sidewall 22, the battery core 4 includes the positive electrode plate 41, the negative electrode plate 42 and the separator film 43, wherein the positive electrode plate 41, the negative electrode plate 42 and the separator film 43 are combined into the battery core 4 by winding or lamination.

Referring to FIG. 5-FIG. 7, the case structure for button battery shown in FIG. 5 includes the upper cover 1, the lower cover 2 and the sealing ring 3, wherein the upper cover 1 and the lower cover 2 are installed with each other in a snap-fit manner, and the relatively sealed space is formed between the upper cover 1 and the lower cover 2; FIG. 6 shows the upper cover 1 in FIG. 5, wherein the upper cover 1 includes the upper segment of first sidewall 11 and the lower segment of first sidewall 12 that are arranged in sequence, and the lower segment of first sidewall 12 is bent in a direction away from the inside of the upper cover 1; FIG. 7 shows the lower cover 2 in FIG. 5, wherein the lower cover 2 includes the bent portion 24, the upper segment of second sidewall 21, the platform structure 23, and the lower segment of second sidewall 22 arranged in sequence; the bent portion 24 is located at the top portion of the lower cover 2, the bent portion 24 is bent in a direction towards the inside of the lower cover 2, the upper segment of second sidewall 21 has a diameter greater than that of the lower segment of second sidewall 22, the inner wall of the upper segment of second sidewall 21 is perpendicular to the inner wall of the platform structure 23, the inner wall of the platform structure 23 is perpendicular to the inner wall of the lower segment of second sidewall 22; the inner wall of the platform structure 23 is closer to the top portion of the lower cover 2 relative to the bottom portion of the lower cover 2; the sealing ring 3 is installed between the upper cover 1 and the lower cover 2 and configured to seal the space between the upper cover and the lower cover, the sealing ring 3 is installed in the inner cavity formed by the upper segment of second sidewall 21 and closely attached to the inner wall of the upper segment of second sidewall 21, the bottom portion of the sealing ring 3 abuts against the platform structure 23, and the platform structure 23 is configured to restrain the axial movement of the sealing ring 3 along the lower cover 2; the annular insertion sealing groove 31 is provided in the inner wall of the sealing ring 3 along the circumferential direction of the sealing ring 3, the lower segment of first sidewall 12 of the upper cover 1 is inserted into the insertion sealing groove 31 to realize sealing fit, and the bent portion 24 is snap-fitted with the top wall of the sealing ring 3 so as to close the seal; the upper segment of first sidewall 11, the lower segment of first sidewall 12 are both located in the inner cavity formed by the upper segment of second sidewall 21; the upper segment of first sidewall 11 has a smaller inner wall diameter than that of the lower segment of second sidewall 22; the battery core 4 is installed in the inner cavity formed by the lower segment of second sidewall 22, the battery core 4 includes the positive electrode plate 41, the negative electrode plate 42 and the separator film 43, wherein the positive electrode plate 41, the negative electrode plate 42 and the separator film 43 are combined into the battery core 4 by winding or lamination.

Finally, it should be indicated that various embodiments above are merely used for illustrating the technical solutions of the present disclosure, rather than limiting the same; while the detailed description is made to the present disclosure with reference to various preceding embodiments, those ordinarily skilled in the art should understand that they still could modify the technical solutions disclosed in various preceding embodiments, or make equivalent substitutions to some or all of the technical features therein; and these modifications or substitutions do not make corresponding technical solutions essentially depart from the scope of the technical solutions of various embodiments of the present disclosure.

### INDUSTRIAL APPLICABILITY

To sum up, the present disclosure provides a case structure for button battery, a button battery and an electric device, wherein the case structure for button battery is simple in structure and low in cost, and can solve the technical problems that deformation and leakage easily occur to button batteries during use.

1. A case structure for button battery, comprising:
an upper cover;
a lower cover, wherein the upper cover and the lower cover are installed with each other in a snap-fit manner;
the lower cover comprises an upper segment of second sidewall and a lower segment of second sidewall, wherein the upper segment of second sidewall has a diameter greater than that of the lower segment of second sidewall; and
a sealing ring, wherein the sealing ring is installed between the upper cover and the lower cover, and configured to seal the upper cover and the lower cover,
wherein the sealing ring has a height adapted to a height of the upper segment of second sidewall, and the sealing ring is installed in an inner cavity formed by the upper segment of second sidewall, and is tightly attached to an inner wall of the upper segment of second sidewall; and
the upper cover is installed in the inner cavity formed by the upper segment of second sidewall, and a battery core is installed in an inner cavity formed by the lower segment of second sidewall.

2. The case structure for button battery according to claim 1, wherein a platform structure is provided between the upper segment of second sidewall and the lower segment of second sidewall, and the platform structure is configured to restrain axial movement of the sealing ring along the lower cover.

3. The case structure for button battery according to claim 2, wherein a distance between the platform structure and a bottom portion of the lower cover is 2-6 mm.

4. The case structure for button battery according to claim 2, wherein the inner wall of the upper segment of second sidewall is perpendicular to an inner wall of the platform structure, and the inner wall of the platform structure is perpendicular to an inner wall of the lower segment of second sidewall.

5. The case structure for button battery according to claim 4, wherein a distance between the inner wall of the platform structure and the bottom portion of the lower cover is equal to a distance between the inner wall of the platform structure and a top portion of the lower cover; or with respect to the bottom portion of the lower cover, the inner wall of the platform structure is closer to the top portion of the lower cover.

6. The case structure for button battery according to claim 1, wherein the diameter of the upper segment of second sidewall is less than 20 mm.

7. The case structure for button battery according to claim 1, wherein a ratio of the diameter of the upper segment of second sidewall to the diameter of the lower segment of second sidewall is 1:0.8-0.98.

8. The case structure for button battery according to claim 1, wherein the upper cover comprises an upper segment of first sidewall and a lower segment of first sidewall;
the upper segment of first sidewall has a smaller diameter than that of the lower segment of first sidewall; and
a transitional inclined side wall is provided between the upper segment of first sidewall and the lower segment of first sidewall.

9. The case structure for button battery according to claim 1, wherein the battery core comprises a positive electrode plate, a negative electrode plate and a separator film; and
the positive electrode plate, the negative electrode plate and the separator film are combined into the battery core by winding or lamination.

10. The case structure for button battery according to claim 9, wherein a main material of the positive electrode plate comprises any one or a combination of lithium cobaltate, lithium manganate, lithium cobalt nickel manganate, lithium cobalt nickel aluminate, and lithium iron ferrous phosphate; and/or
a main material of the negative electrode plate comprises any one or a combination of lithium titanate, silicon carbon, artificial graphite, and natural graphite; and/or a material of the separator film comprises any one of polyethylene, polypropylene, polyethylene terephthalate and polyimide.

11. The case structure for button battery according to claim 1, wherein a material of the sealing ring comprises either or a combination of polyethylene and polypropylene.

12. The case structure for button battery according to claim 8, wherein an annular insertion sealing groove is provided in a top wall of the sealing ring along a circumferential direction of the sealing ring, and the insertion sealing groove is configured to be connected with the lower segment of first sidewall of the upper cover by insertion; and
the lower segment of first sidewall of the upper cover is inserted into the insertion sealing groove of the sealing ring for sealing fit.

13. The case structure for button battery according to claim 8, wherein the upper segment of first sidewall has an inner wall diameter equal to that of the lower segment of second sidewall.

14. The case structure for button battery according to claim 1, wherein the upper cover comprises the upper segment of first sidewall and the lower segment of first sidewall arranged in sequence, and the lower segment of first sidewall is bent in a direction away from the inside of the upper cover;
an annular insertion sealing groove is formed in the inner wall of the sealing ring along the circumferential direction of the sealing ring, and the insertion sealing groove is configured to be connected with the lower segment of first sidewall of the upper cover by insertion; and
the lower segment of first sidewall of the upper cover is inserted into the insertion sealing groove of the sealing ring to achieve a seal fit.

15. The case structure for button battery according to claim 14, wherein a diameter of the inner wall of the upper segment of first sidewall is smaller than that of the lower segment of second sidewall.

16. The case structure for button battery according to claim 1, wherein the top portion of the lower cover is provided with a bent portion circumferentially extending along the top portion of the lower cover, and the bent portion is configured to be snap-fitted with the sealing ring.

17. A button battery, comprising the case structure for button battery according to claim 1.

18. An electric device, comprising the button battery according to claim 17.

19. The case structure for button battery according to claim 3, wherein the inner wall of the upper segment of second sidewall is perpendicular to an inner wall of the platform structure, and the inner wall of the platform structure is perpendicular to an inner wall of the lower segment of second sidewall.

20. The case structure for button battery according to claim 2, wherein the diameter of the upper segment of second sidewall is less than 20 mm.
